(19) United States
(12) Patent Application Publication
(10) Pub. No.: US 2002/0026398 A1
(43) Pub. Date: Feb. 28, 2002

(54) Storefront for an electronic marketplace for services

(76) Inventor: Beerud D. Sheth, Sunnyvale, CA (US)

Correspondence Address: FENWICK & WEST LLP, TWO PALO ALTO SQUARE, PALO ALTO, CA, 94306, US

(21) Appl. No.: 09/728,033

(22) Filed: Dec. 1, 2000

Related U.S. Application Data
(63) Continuation-in-part of application No. 09/648,408, filed on Aug. 24, 2000.

(51) Int. Cl. G06F 17/60

(52) U.S. Cl. 705/37; 705/26; 705/27; 705/80

(57) ABSTRACT

A method and system for buying and selling services online includes a process for custom services, a commodity process and a collaborative workspace on a website. The process for custom services includes the posting by a buyer of specific criteria for a desired service, the bidding by a seller to perform the service, and the selection of a seller by the buyer. The commodity process includes the posting by a seller of a service offering, the posting by the buyer of requirements for the purchase of the service offering, and the purchase of a service offering by the buyer. The commodity process may also include an optimization process that provides the buyer with an optimized list of service offerings. The collaborative workspace includes communication tools, a file structure, workbenches and project management tools used by the buyer and seller for facilitating the setup, development and release of one or more services.

### CROSS-REFERENCE TO RELATED APPLICATION

This application is a continuation in part of U.S. patent application Ser. No. 09/648,408, “Method and Apparatus for an Electronic Marketplace for Services Having a Collaborative Workspace,” by Sheth and Anumolu, filed Aug. 24, 2000, the entirety of which is herein incorporated by reference.

### BACKGROUND

A. Technical Field

The present invention relates generally to online marketplaces, and more particularly, to an online marketplace for services including a collaborative workspace.

B. Background of the Invention

The nature of business is changing. The management, procurement and delivery of services are becoming decentralized as businesses increasingly outsource for their needs. New kinds of business organizations are emerging as employees seek greater flexibility through working independently. Large, vertically integrated companies are being replaced by fluid, self-managed groups of diverse individuals who form online teams, engage in a common task and disband after the project's completion. In this new economy, there is a strong need for infrastructure that can facilitate sourcing, buying and selling services more efficiently.

The traditional market for services, both online and offline, is highly fragmented. In the offline world, a buyer of services has traditionally located service providers through the local telephone directory, print publications or personal referrals. Once a service provider was located, however, the buyer had to contact him or her, arrange a method or time to review his or her prior work or otherwise evaluate his or her qualifications for the project and negotiate a price. Even in the age of the Internet, thousands of service providers, both individuals and companies, offer their services, but their individual web sites or online postings are often difficult to find or do not disclose sufficient information regarding the quality of their work product, reputation or availability. Furthermore, a buyer of services still has to contact each vendor individually through email, evaluate their qualifications and negotiate specifications, availability and price on an individual basis. As a result, comparison shopping, negotiation and collaboration with services providers have traditionally been time-consuming, inefficient and costly for the buyer of services.

Online marketplaces for physical goods have successfully aggregated vendors and enabled customers to compare prices and make such purchases more efficiently. In contrast to online marketplaces for physical goods, however, online marketplaces for services are significantly more complex because each service is performed on a custom order basis and each end product is unique. The process of creating and delivering a service is more critical than with most products, as the buyer and seller of services must work collaboratively to define the parameters of the project and develop a finished product that meets the specifications of the buyer. In addition, unlike in product marketplaces, the lowest cost provider of services does not necessarily win the project because the buyer's decision may not only be based on price, but also on the quality of the service provider's work product, reputation and delivery date.

The fragmentation of the traditional market for services both online and offline has therefore created a strong need for infrastructure that can facilitate access to service providers and their services in an efficient manner.

In addition, as the required services become more complex and numerous, it is often problematic for a single online provider to supply all the needs of a particular buyer or buyers. Furthermore, for certain types of services, such as commodity services, many buyers do not care which of several possible service providers supply the service.

The present invention provides a method and system for buying and selling services online including a process for custom services, a commodity process, and a collaborative workspace on a website. The process for custom services includes the posting by a buyer of specific criteria for a desired service, the bidding by a seller to perform the service, and the selection of a seller by the buyer. The commodity process includes the posting by a seller of a service offering, the posting by the buyer of requirements for the purchase of the service offering, and the purchase of a service offering by the buyer. The commodity process may also include an optimization process that provides the buyer with an optimized list of service offerings. The collaborative workspace includes communication tools, a file structure, workbenches and project management tools used by the buyer and seller for facilitating the setup, development and release of one or more services.

### SUMMARY OF THE INVENTION

The present invention offers buyers and sellers of services an online platform for the transaction, development and delivery of remote services. By uniquely combining (i) an exchange, (ii) a collaborative workspace and (iii) fulfillment processes, the described infrastructure enables buyers and sellers of services to come together online, specify the services required, identify and contact each other (or multiple service providers at once) regarding a particular project, transact with each other, develop collaboratively the final product online, deliver the service over an electronic network, and create and access virtual offices to maintain permanent information.

More specifically, the present invention joins buyers of services and independent service providers in temporary, collaborative networks to complete projects. By creating an open Request for Proposal (RFP) environment where interested service providers respond to the projects posted by buyers, the exchange component enables buyers and service providers to transact using competitive bidding as a pricing mechanism. Buyers and service providers can also transact in the commodity or “Fixed Price (FP) marketplace,” where buyers browse through the listings of service providers online, evaluate and directly select a service provider at a posted fixed price for pre-specified services. In both of these formats, buyers evaluate service providers based on several criteria: (a) each service provider's online profile, which lists relevant skills and experience and includes a portfolio of past work; (b) the feedback service providers have received from prior projects conducted through the described infrastructure; and (c) through direct communication in the form of bids submitted and online discussions.

The collaborative workspace component enables buyers and service providers to collaborate on the project, even though they may be physically located thousands of miles apart. Each project is assigned a secure, dedicated workspace that provides online meeting facilities, project management and organization tools and industry-specific applications. Not only does the workspace facilitate development of the finished product, but it also enables final delivery of the service. Unlike marketplaces for physical goods, the “product” brokered by the described infrastructure is predominantly digital, and so the “delivery and handling” part of the process is completed online in the secure workspace shared by the buyer and service provider. Once the transaction is completed, both buyers and service providers rate each other. Buyers evaluate service providers on quality, responsiveness, timeliness and professionalism. Service providers rate buyers on clarity of project-specification, responsiveness, professionalism and reliability of payment.

The described invention is a tightly integrated infrastructure to provide an efficient and comprehensive system for the transaction, development and delivery of remote services. The invention affords buyers and sellers of services the flexibility to transact on an as-needed basis at any time or day or night and facilitates faster and more cost-effective outsourcing. When a project is finished after one day, one month or even one year, the network of independent entities that assembled to complete a specific project dissolves, and its members become independent agents once again until the next project arises.

In one embodiment of the present invention, the buyer purchases a service commodity via a storefront by entering prompted information on a computer terminal. This information is transferred over a network to a storefront service module. The storefront service module uses the information to assign a service request to one of a group of specially identified service providers. Once the service provider completes the service, the deliverable is returned to the storefront service module and the storefront service module, in turn, presents the deliverable to the buyer for pickup.

### BRIEF DESCRIPTION OF THE DRAWINGS

FIG. 1 is a diagram of a system including a described embodiment of the present invention.

FIG. 2 is a diagram of an example of a server site.

FIG. 3 is a block diagram of a data structure for a collaborative workspace.

FIG. 4 is a diagram of one embodiment of a file structure used to implement workspaces.

FIG. 5a is a screen shot of the user interface for posting a RFP.

FIG. 5b is a user interface for posting a fixed-price service offer.

FIG. 5c is a user interface for placing a bid on a project.

FIG. 6a is a screen shot of the user interface for per project workspaces.

FIG. 6b is a screen shot of a user interface for a shared folder.

FIG. 6c is a screen shot of a user interface for a private message board.

FIG. 7 is a user interface showing a list of current requests for proposals (RFPs) available on the website.

FIG. 8 is a user interface showing a list of current fixed-price services available on the website.

FIG. 9 is a user-specific page on the website.

FIG. 10 is a flow diagram of the RFP process.

FIG. 11 is a flow diagram of the commodity process.

FIG. 12 is a flow diagram of a work process within the sandbox.

FIG. 13 is a flow diagram of the optimizer related process used for commodity services.

FIG. 14 is a flow diagram of the optimization process.

FIG. 15 is a block diagram of a preferred embodiment of a system for providing storefront services.

FIG. 16 is a flow diagram of a preferred embodiment of the storefront process.

FIG. 17 is a flow diagram of a preferred embodiment of the process for adding a service provider to the database.

FIG. 18 is a screen shot of a user interface for a storefront service.

FIG. 19 is a depiction of a user interface for confirming a storefront purchase.

FIG. 20 is a depiction of a user interface of a confirmation of a storefront purchase.

### DETAILED DESCRIPTION OF THE PREFERRED EMBODIMENTS

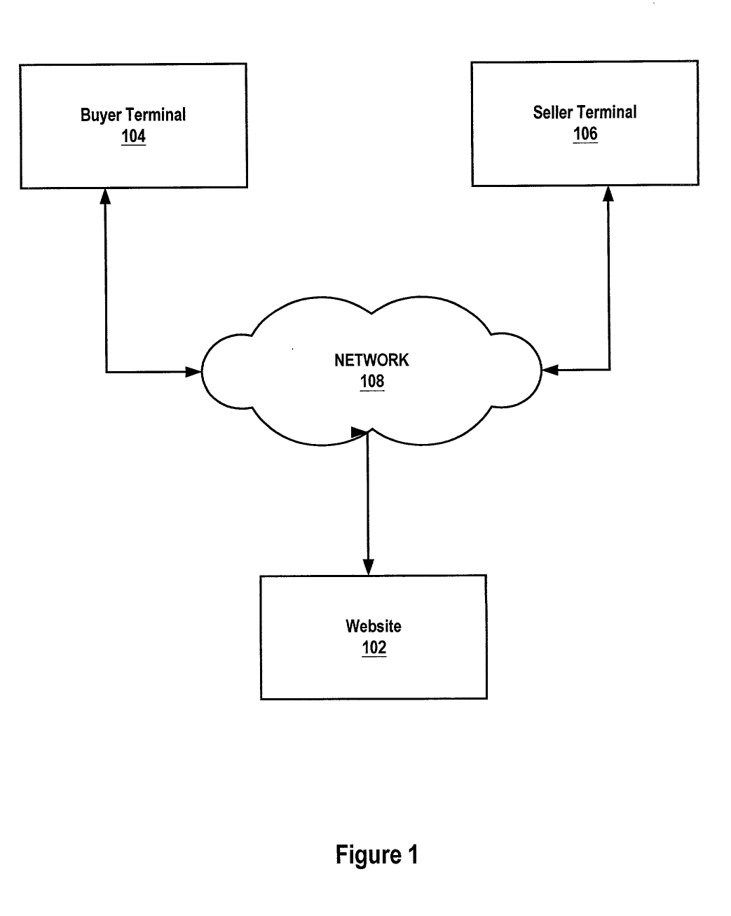

FIG. 1 is a diagram of a system including a described embodiment of the present invention. The system includes a server hosting a website 102 (hereinafter “website”), a buyer terminal 104, a seller terminal 106 and a network 108, such as the Internet. The buyer terminal 104, the seller terminal 106 and the website 102 are all connected via the network 108. As a result, the buyer and the seller can communicate via their terminals 104, 106 using the website 102. In this embodiment, the buyer terminal 104 and the seller terminal 106 may include one or more computer systems such as desktop computers, laptop computers, network computers, handheld data storage devices, wireless communication devices, cellular telephones, etc. A preferred embodiment of the present invention is implemented in a client-server environment as shown herein. The Internet is one example of a client-server environment. However, any other appropriate type of client-server environment, such as an intranet, a wireless network, a telephone network, etc. may also be used. The present invention is not limited to the client-server model and could be implemented using any other appropriate model. The described embodiment uses the world-wide-web, although other protocols may used and other, newer versions of the web may also be used.

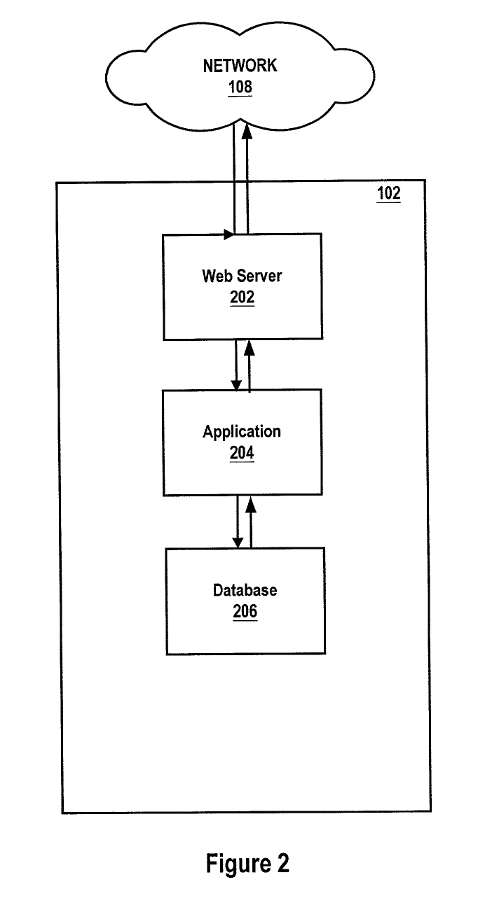

FIG. 2 is a diagram of the website 102. The website 102 includes a web server 202, an application 204 and a database 206. The web server 202 provides the connection to the network 108. The application 204 implements the steps necessary to communicate with the buyer terminal 104 and the seller terminal 106. The application 204 further generates information based on the communications with the buyer terminal 104 and the seller terminal 106. The database 206 includes memory storage of information received from the buyer terminal 104 and the seller terminal 106 and information generated by the application 204. The generation and storage of information is discussed in greater detail below.

Although, in this embodiment, the server 202 is shown as a single unit, it may include one or more computer systems. The generation and storage of information as described herein is preferably performed by instructions stored in a memory and executed by a computer processor, although the invention is not limited to this embodiment. These instructions may be stored on a computer-readable medium, such as a floppy disk, CD ROM, or any other appropriate storage medium.

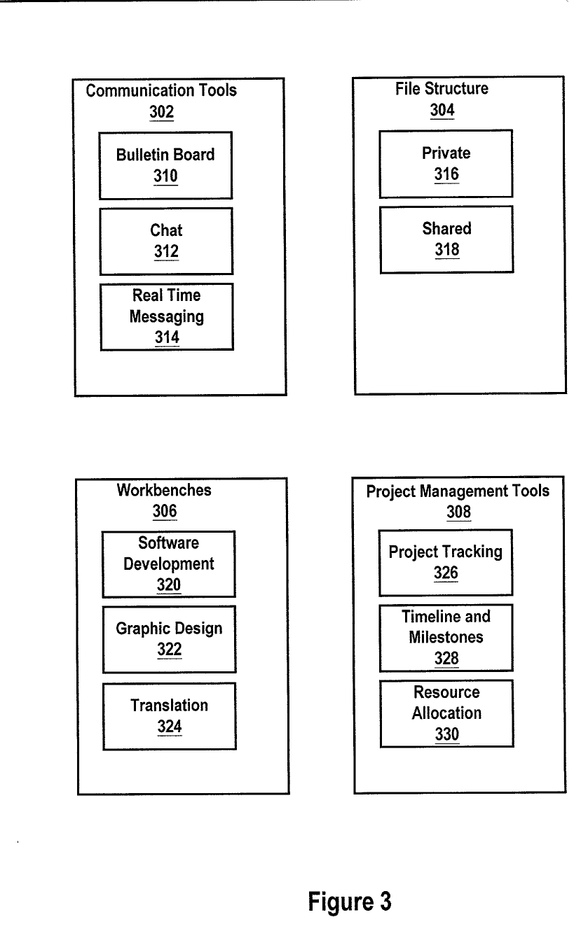

FIG. 3 is a block diagram of a data structure for a collaborative workspace 300. The application 204 generates a unique workspace 300 for each project that is initiated using the website 102. The workspace 300 is stored in the database 206. The workspace 300 is where sellers develop and deliver services. Buyers can track the service as the seller develops it within the workspace 300 and then can pick up the finished service from the workspace 300. The workspace 300 includes communication tools 302, a file structure 304, workbenches 306, and project management tools 308. The communication tools 302 facilitate communications between the buyer and the seller and may include one or more bulletin or message board systems 310, real time chat room systems 312, and real time messaging systems 314. The communication tools 302 may also include any other means of communication that is implemented over a network such as integrated online meetings with real time document sharing and annotation, web tours, and application sharing. The buyer and the seller may use the communication tools 302 to discuss the details of their project anytime after the application 204 has initiated the project.

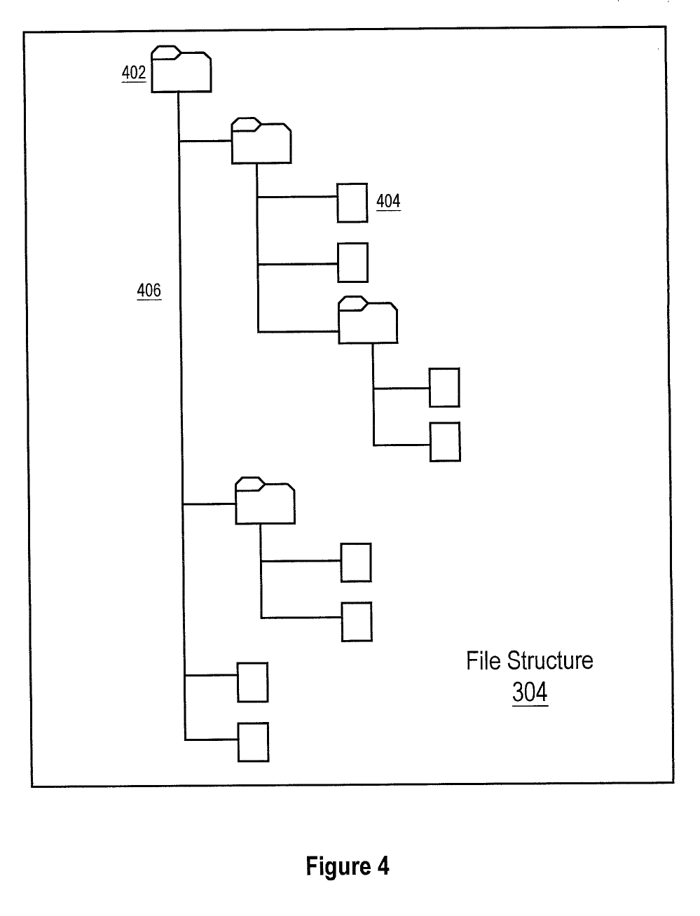

The file structure 304 includes private folders 316 and shared folders 318. The file structure is discussed in more detail in the description of FIG. 4.

The workbenches 306 may include at least software development 320, graphic design 322, and translation 324 each of which may be used by the seller for the development of services. The workbenches 306 may also include web-enabled versions of routine-use products, productivity tools for efficient work, and industry-specific workbenches.

The industry-specific workbenches are specially designed for the type of service provided. For instance, for a software services provider, the workbenches may include telnet access to a remote host, a file editor for editing text files, a compiler, a source code control system for tracking source code versions, a debugging environment for debugging remote code, a test environment for evaluating software, deployment and remote hosting of software applications, and access to other third party tools. Another example of industry-specific workbenches lies in graphic design services. Workbenches for this area include applications such as AutoCAD and Photoshop, graphic filters and software plug-ins for industry standard software tools, tools for inserting digital watermarks to prevent piracy, access to third party tools, and access to collections of clip-art, photographs, caricatures, etc.

Since the services are being developed and delivered online and may involve multiple vendors working together on one or more projects, project management tools are used to facilitate the organization of these multiple, simultaneous projects. The project management tools include tracking project status in summarized and detailed forms, tracking project timelines and milestones, and resource, cost and time allocation.

Buyers and sellers may also use the workspace 300 even when they are not currently transacting through the online marketplace. For example, if a seller does not currently have a buyer for a service, the seller may still develop the service and create and store files in the workspace 300. Similarly, when buyers and sellers are not currently transacting they may still maintain a virtual office within the website 102. Buyers may store details on their service needs, preferences, transaction history, billing and preferred vendors. Sellers may store details on skills and certification, reputation, transaction history, billing and preferred buyers. This information is maintained in the database 206 of the website 102.

FIG. 4 is a diagram of one embodiment of a file structure 304. The file structure 304 includes folders 402 and files 404 organized in a manner commonly found on computer systems. Each folder 402 may contain one or more additional folders 402 and/or files 404. The files 404 and folders 402 are organized in a hierarchical manner 406 that facilitates easy access to each file 404. The file structure 304 may be the same for both the private workspace 316 and the shared workspace 318. The workspace 300, however, is not limited to this file structure 304 and may also use other methods of organizing stored files. When accessing files 404 in the workspace 300 through the use of the file structure 304, the buyer and seller may use various operators to manipulate the files 404. These operators may include creating new files, editing files, storing links to web pages in the form of URLs, uploading and downloading files from/to a local computer, renaming files, and moving files. The ability of the buyer and seller to use these operators may be restricted for certain files or certain versions of a file. For instance, access to files 404 in a private folder 316 is restricted to either the buyer or the seller depending on which of them owns the files. Access to files 404 in a shared folder 318 may be accessible by both the buyer and seller of a given project but not by all users of the marketplace. A seller may also specify that a certain file be accessible to other sellers or be publicly available.

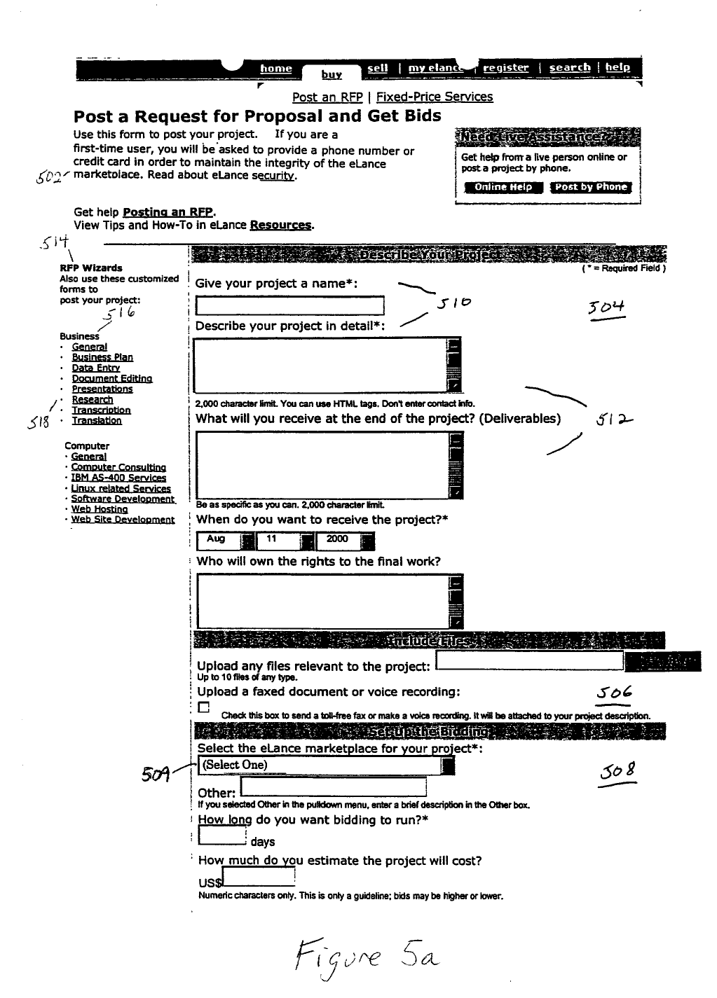

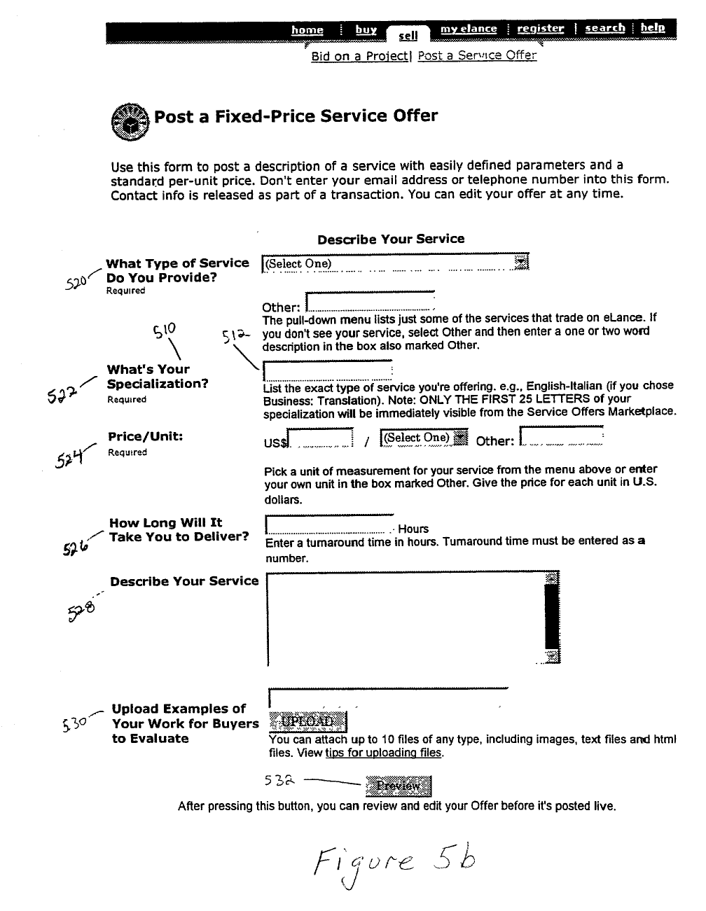

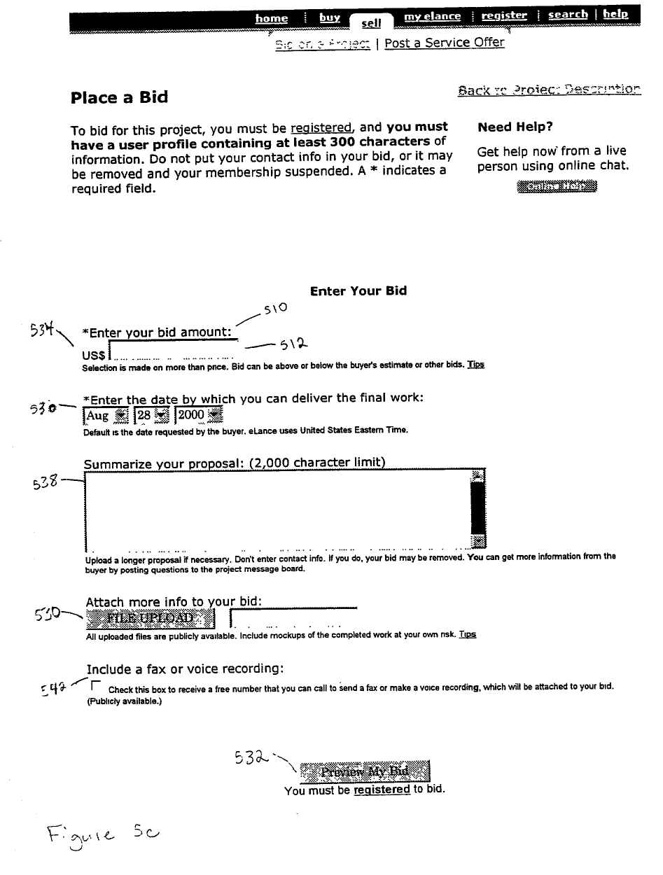

FIG. 5a is a screen shot of the user interface for posting a RFP. This page 502 includes a project description area 504, an upload area 506, and a bidding area 508. These areas contain user prompts 510 and areas for the user to enter information 512 based on these prompts 510. In the bidding area 508, the user may select a marketplace for the project. The user may choose this marketplace from a selection of categories 509 or may define another category for the project. The page 502 may also contain RFP wizards 514. The wizards 514 are used to customize the prompts 510 in the project description area 504, upload area 506, and bidding area 508. The wizards 514 vary by category 516 and subcategory 518. By activating a wizard 514 in a certain category 516 or subcategory 518, the user can have access to prompts 510 that are customized to that category 516 or subcategory 518. In this manner, the user is able to post an RFP with information that is tailored to the type of project that the user is posting.

FIG. 5b is a user interface for posting a fixed-price service offer. The seller, or service provider, provides the information for the fixed-price service offer. Like the interface for posting a RFP, this interface contains user prompts 510 and areas for the user to enter information 512 based on these prompts 510. The areas include the type of service offered 520, the service provider's specialization 522, the price per unit for the service 524, the delivery time 526, and a description of the service 528. The interface also includes an upload area 530 where the service provider may attach files for the buyer to evaluate. The interface also contains a preview button 532 that allows the seller to see the fixed-price service offer before it is posted.

FIG. 5c is a user interface for placing a bid on a project. This interface, like the previous interfaces, also contains prompts 510 and areas for the user to enter information 512 based on these prompts 510. The areas include the amount of the bid 534, the date for delivering the service 536, and a summary of the proposed service 538. Like the interface for posting a fixed-price service offer, this interface contains an upload area 530 and a preview button 532. The interface also includes a box 542 that the user may check in order to attach a fax or voice recording to the bid.

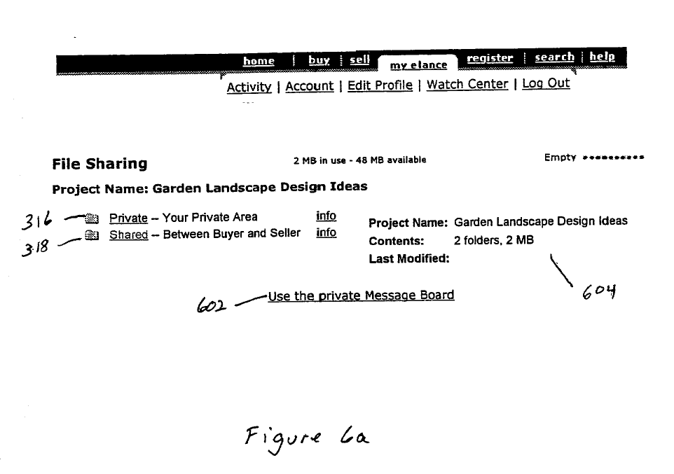

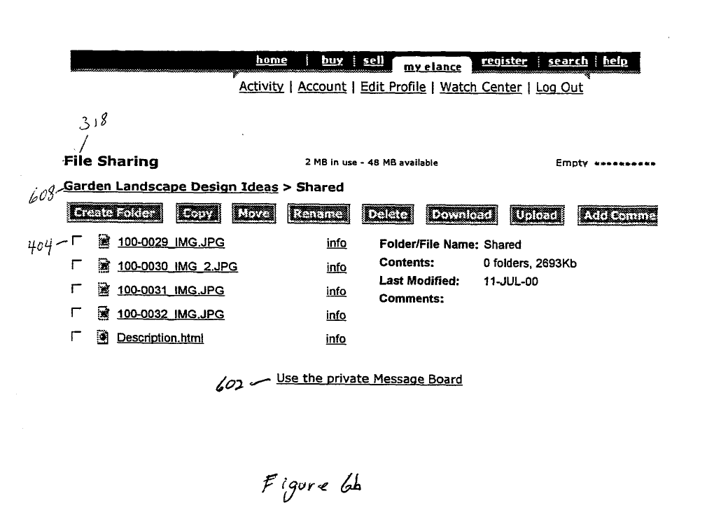

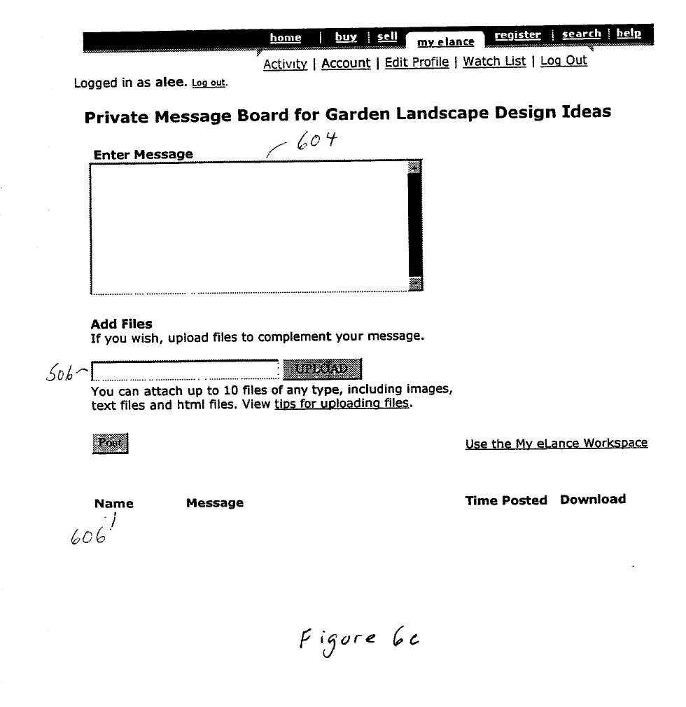

FIG. 6a is a screen shot of the user interface for per project workspaces. As described in the discussion of FIG. 3, the application 204 automatically creates a workspace 300 for each project that is initiated. In this embodiment, the user interface includes a private folder 316 and a shared folder 318. The shared folder 318 contains files 404 accessible by both the buyer and the seller. The private folder 316 contains files 404 accessible by either the buyer or the seller, but not both. The user may move back and forth between the shared and private folders 318, 316 in order to access the desired files 404. The user may also access a private message board through link 602. The user interface for the workspace 300 includes information 604 about the project, which may include the project name, the size of the files uploaded in the workspace 300, and the date the workspace 300 was last modified.

FIG. 6b is a screen shot of an interface to a shared folder 318. From the shared folder 318, the user may access any shared files 404. The user may use the operators 608 to manipulate the files in the folder 318. The operators 608 may include creating a folder, or manipulating a file by copying, moving, renaming, deleting, downloading, uploading, or adding comments to that file.

FIG. 6c is a screen shot of a private message board. The private message board includes a text entry area 604 and an upload area 506. Once the user enters a message in the text entry area 604 and posts the message, the message may be accessed from the message retrieval area 606. The message retrieval area 606 may include information such as the user's name, the title of the message, and the time the message was posted. Both the buyer and the seller have access to the private message board. The user may use the upload area 506 to include files 404 with the user's message.

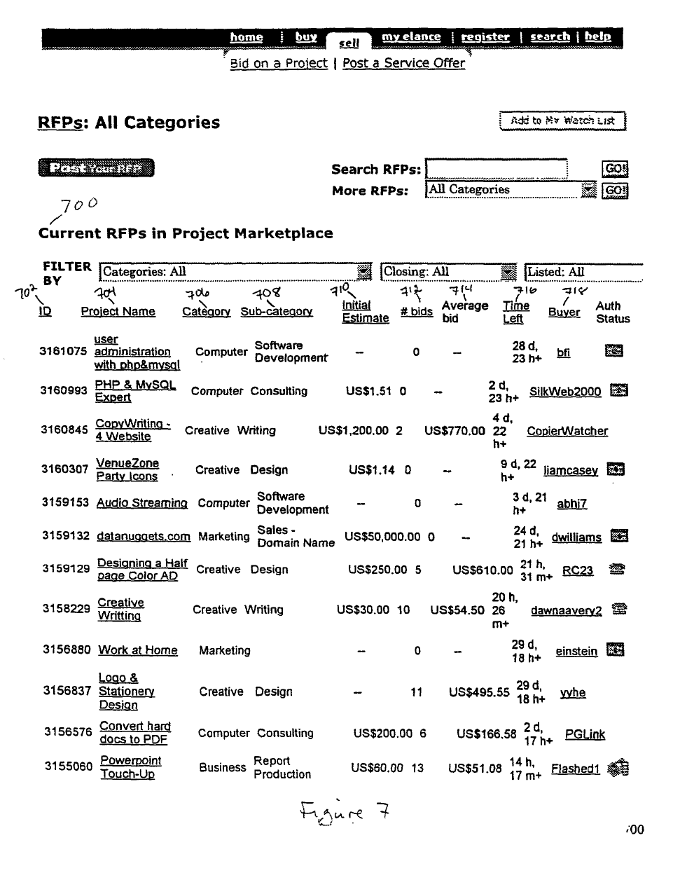

FIG. 7 is a user interface showing a list 700 of current requests for proposals (RFPs) available on the website 102. Each RFP is submitted by a buyer. The list 700 includes information about each RFP, such as the project ID 702, the project name 704, the category 706 and subcategory 708, the initial estimate 710 for the project, the number of bids 714 made on the project, the amount of the average bid 714, the time left 716 to bid on the project, and the buyer's name 718. The seller may browse this list of RFPs and use the information contained in the list to choose one or more projects on which to bid.

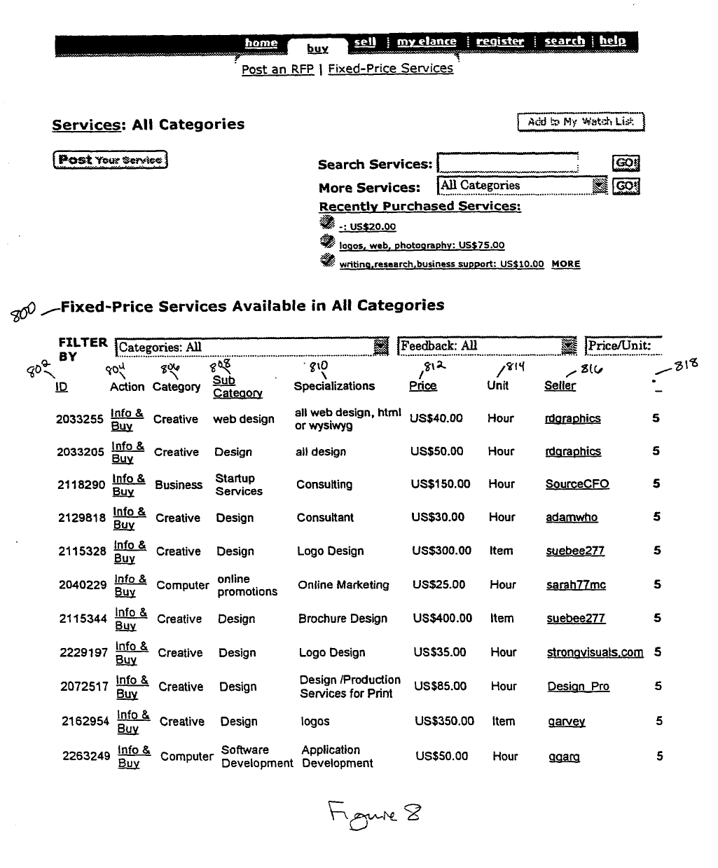

FIG. 8 is a list 800 of current fixed-price services available on the website 102. Each entry in the list 800 is a service offering submitted by a seller. The list 800 includes information about each offered service, such as the project ID 812, the available actions 804 to take on the project, the category 806 and subcategory 808 of the project, the specializations 810 concerning the project, the price 812, the unit 814 of measurement for the price, the seller's name 816, and the rating 818 of that seller. The buyer may browse the list 800 of services and use the information provided to help with the buyer's purchasing decision. The buyer may also choose one of the actions 804 to find out more information about the offered service or to purchase the service.

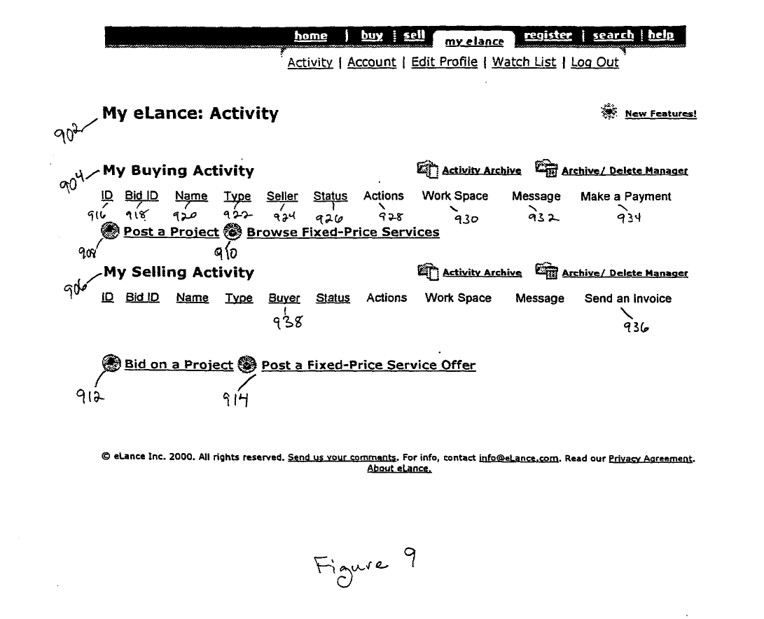

FIG. 9 is a user-specific page 902 on the website 102. The user may be both a buyer and seller of services, thus there is space for both the user's buying activity 904 and the user's selling activity 906. As a buyer, the user may post 908 a project, i.e., an RFP, or the user may browse 910 the fixed-price services offered by sellers. As a seller, the user may bid 912 on an RFP, or the user may post 914 a fixed-price service offer. Once the user has initiated any buying and/or selling activity, information about that activity is displayed in the appropriate space 904, 906. The information includes the project ID 916, the bid ID, 918, the name 920 of the project, the type 922 of project, the seller's name 924 or the buyer's name 938, the status of the project, 926, the actions 928 available for the project, access to the workspace 903, and access to any messages 932 concerning the project. As a buyer, the user has the option to make a payment 934 and as a seller the user has the options to send an invoice 936 to the buyer. With the user-specific page 902, the user is able to access all projects in which the user is involved as either a buyer or a seller.

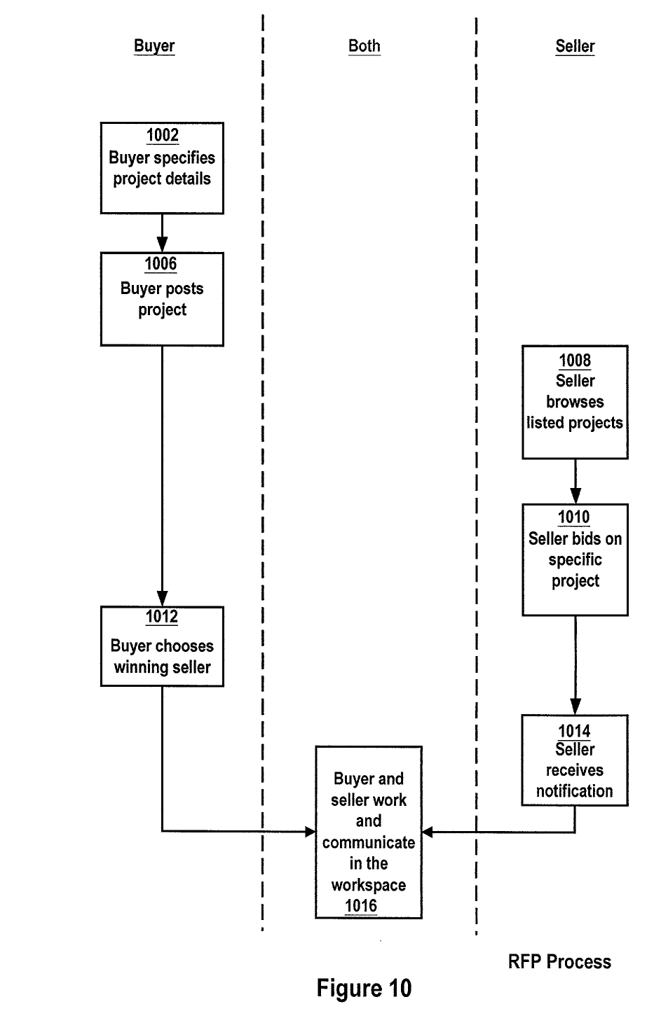

FIG. 10 is a flow diagram of the RFP process. This process is initiated by the buyer. First, the buyer specifies 1002 the project details. The project details may include a project name 704, a description of the service that the buyer is requesting, the category 706 and subcategory 708 for the project, desired pricing 710, and timelines 716. The buyer may also upload relevant files or voice recordings as part of the project details. The buyer then posts 1006 the project. Once the buyer posts 1006 the project, the application 204 adds the project to the list 700 of current RFPs on the website 102. Next, the seller browses 1008 the listed projects. The seller may then participate in an auction for a project by bidding 1010 on that project. The buyer chooses 1012 one or more winning sellers, and these sellers receive 1014 notification of the buyer's choice. The seller may then accept the project. Once the seller has accepted the project, the buyer and seller may work and communicate 1016 in the workspace 300.

The auction may be a regular RFP auction or a Dutch auction. In a regular auction, the buyer specifies the bidding duration, and then sellers may bid on the project. Unless the buyer extends the bidding duration, the auction automatically closes when this duration is reached. In a Dutch auction, the buyer chooses more than one seller to perform the service. In a preferred embodiment, the sellers will perform the service for the same price. The buyer does not have to specify that more than one seller will be selected but has the option to choose more than one seller at any point in the process after the RFP is posted.

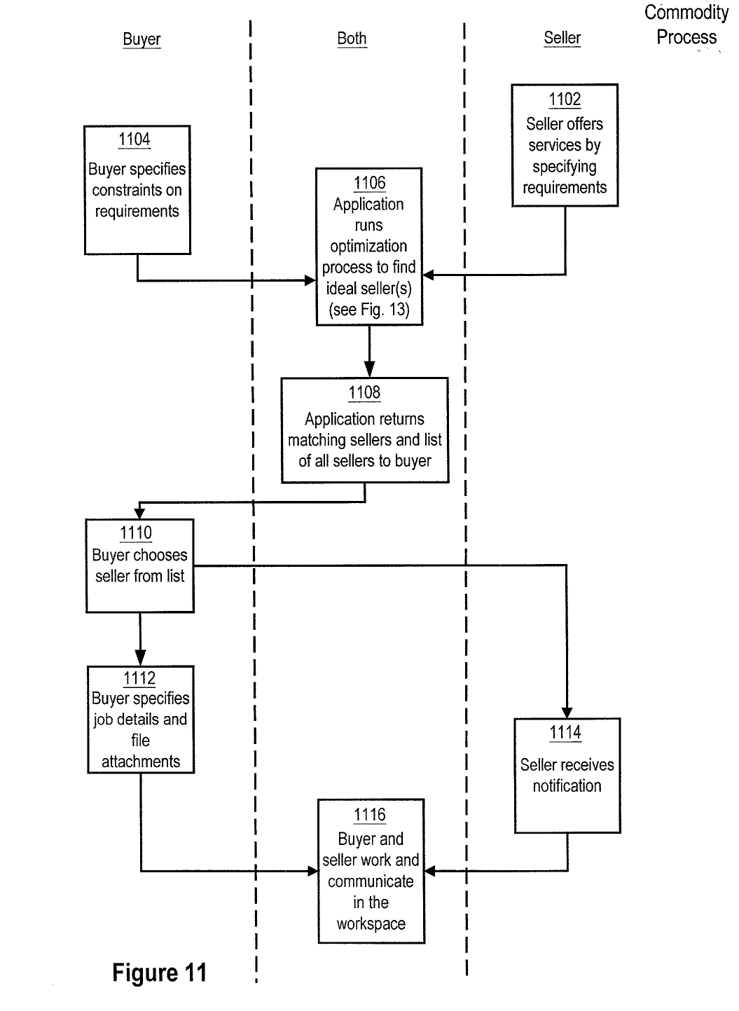

FIG. 11 is a flow diagram of the commodity process. For commodity services, buyers do not need to run an auction. The seller offers services for purchase by specifying 1102 category, price, quantity, availability, turnaround time and other parameters that the seller updates periodically. In the preferred embodiment, the buyers specify 1104 the category and price of the desired service, and the acceptable feedback rating for the seller. The buyer may also specify other constraints such as turnaround time, desired quality, etc. Within the website 102, the application 204 uses optimization techniques to automatically satisfy as many of the buyer's constraints as possible. The optimization process is discussed further below. The application returns 1108 matching sellers and a list of all sellers. The buyer then chooses 1110 a seller from the optimized list. The buyer specifies 1112 the job details and the file attachments, which are then loaded by the application 204 into the workspace 300 for the project. The application 204 notifies 1114 the seller of the buyer's choice. The buyer and seller work and communicate 1116 in the workspace 300.

For both custom and commodity services, as the process unfolds, the application 204 proactively alerts the market participants to relevant events, such as whether the auction for a project has closed, whether the seller has accepted or declined a project, and whether a project is completed. The described embodiment can contact the buyer and seller with email, pager, phone, fax, mobile phone, etc. The options for being contacted are specified by the user. For instance, a seller may choose to be called at a certain phone number during certain times of the day. This process of reaching the buyer and seller through means other than the network 108 allows the website 102 to bridge the offline and online worlds by notifying the participants in the real world of events that occur in the online world.

Market participants that transact with each other using the website 102 are able to rate their counter-parties. These ratings are stored in the database 206. In a preferred embodiment, buyers and sellers are each rated among several distinct criteria. The feedback may include whom a buyer or seller has worked with in the past, what comments the rater had, and even contact information to facilitate using the rater as a reference. Since the buyer and seller are collaborating on the project, the feedback is bilateral with the buyer rating the seller and the seller rating the buyer. The feedback is accessible to all users of the marketplace. The feedback is not averaged for the specific user rather each project has unique feedback even if the seller or buyer has been involved in more than one project. This feedback system is an effective countermeasure to fraud in the marketplace. Reputation is important in services because services frequently involve recurring transactions and not onetime transactions. Vendors will realize the importance of developing a positive reputation in order to win more auctions and also increase their pricing. The reputation they develop will also dissuade venders from doing transactions off-line as then those transactions will not add to their reputation.

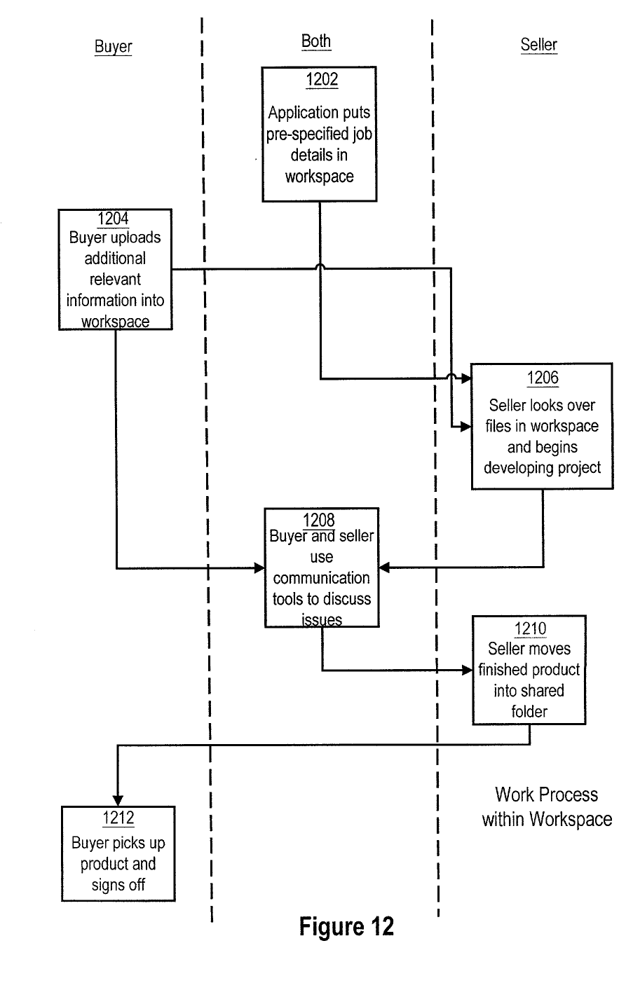

FIG. 12 is a flow diagram of an example work process within the workspace 300. The application 204 puts 1202 the job details and file attachments that were previously specified 1112 by the buyer into the workspace 300. The buyer may then upload 1204 additional, relevant information into the shared or private folder 318, 316 in the workspace 300. The seller then looks over 1206 the files in the shared folder 318 of the workspace 300. The seller next begins developing the project using development tools and storing files in the seller's private folder 316. During the development time, the buyer and seller may use communications tools 302 to discuss 1208 issues surrounding the service development. Once the project is completed, the seller moves 1210 the finished product into the shared folder 318 of the workspace 300. The buyer then coordinates with the seller regarding payment for the services, picks up 1212 the released product from the workspace 300, and signs off. The seller can also develop the project on his local machine and upload the results to the workspace, but this loses much of the advantage of having the workplace, since the buyer is less able to track the progress of the project.

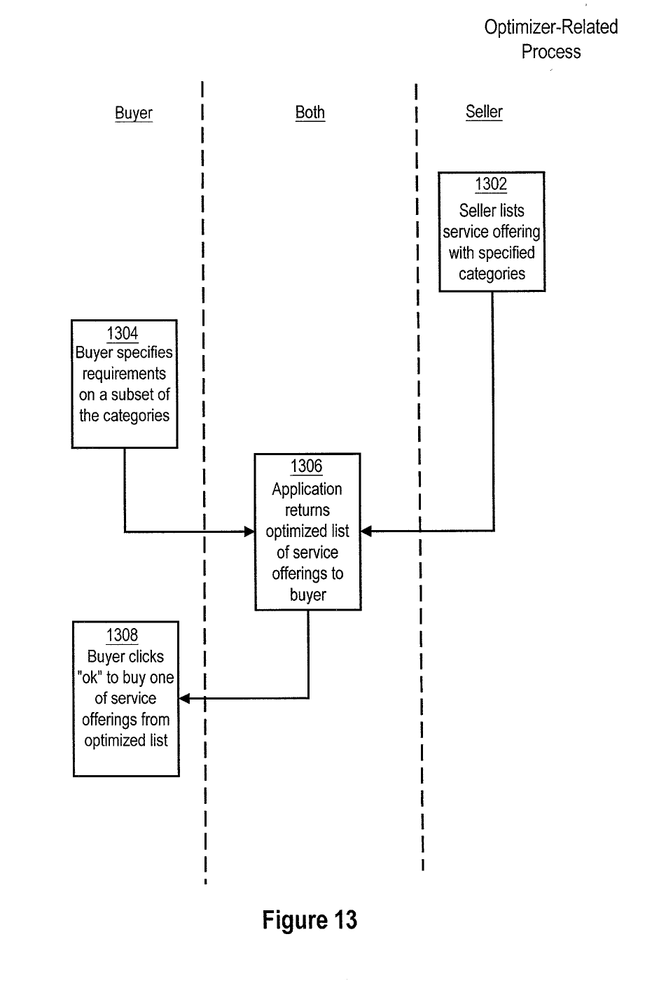

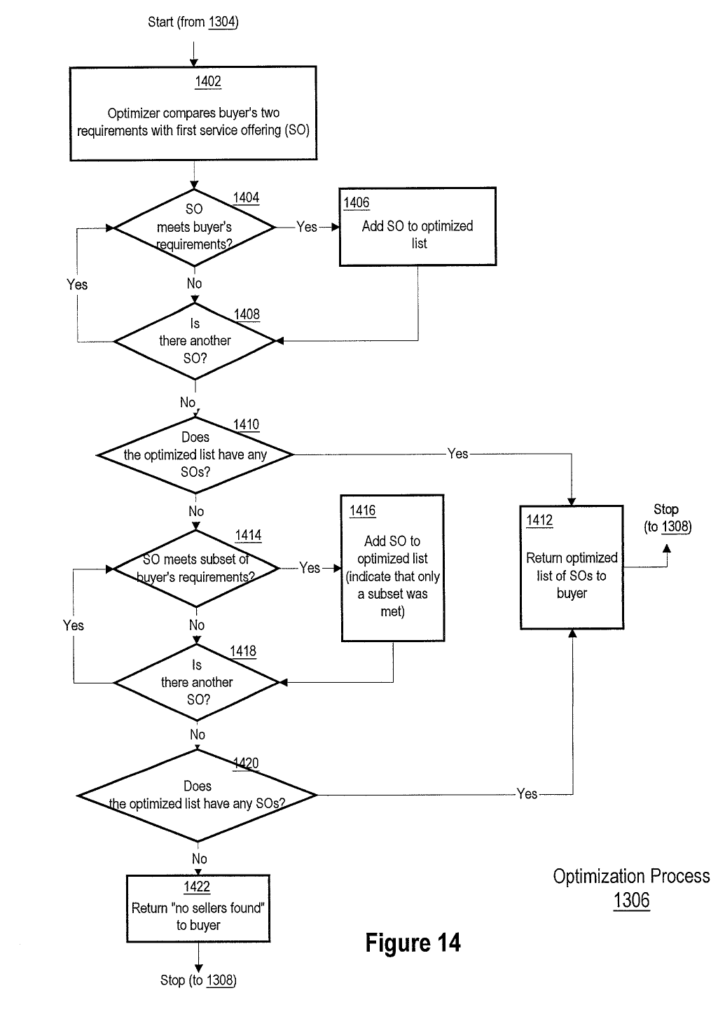

FIG. 13 is a flow diagram of the optimizer-related process used for commodity services. This process is used to assist the buyer in choosing a service offering for purchase. The process is initiated by the seller when the seller lists 1302 one or more offerings. These offerings are displayed in the list 800 of fixed-price services shown in FIG. 8. The seller specifies a number of requirements which may include price, quantity, ownership rights, and delivery time for each offering (see FIG. 5). The buyer specifies 1304 the requirements on a subset of these categories, e.g., the buyer may specify 1304 a required price and quantity or a required quantity and delivery time. The requirements may also be in ranges, e.g., delivery anytime in August or price $15-$20 per hour. The application then returns 1306 the optimized list of service offerings. This optimization process is discussed below in detail in connection with FIG. 14. The buyer clicks 1308 “ok” to buy one of the service offerings from the optimized list.

FIG. 14 is a flow diagram of the optimization process 1306. The optimizer compares 1402 the buyer's two requirements with the first service offering. If the service offering meets 1404 both of the requirements of the buyer, then that service offering is added 1406 to the optimized list of service offerings. If the service offering does not meet 1404 the requirements, then the application looks 1408 for another service offering. The application also looks 1408 for another service offering after a service offering is added 1406 to the optimized list. In both cases, if there is another service offering, then the application does the same comparison 1402 for the next service offering.

If there are no more service offerings, then the application checks whether the optimized list contains 1410 any service offerings. If the optimized list contains 1410 service offerings, then the application returns 1412 the optimized list of service offerings to the buyer. If the optimized list contains 1410 no service offerings, then the application again compares the buyer's two requirements with the first service offering. If the service offering meets 1414 one (or a subset) of the buyer's requirements, then that service offering is added 1416 to the optimized list. Optionally, the offering is noted on the list as having met only a subset of the requirements. If the service offering does not meet 1414 any of the buyer's requirements, then the application checks 1418 for another service offering. The application also checks 1418 for another service offering after adding 1416 a service offering to the optimized list. As above, if there is another service offering, then the application checks whether the next service offering meets 1414 one of the buyer's requirements.

If there are no more service offerings for the second comparison round, then the application checks whether the optimized list contains 1420 any service offerings. If the optimized list contains 1420 service offerings, then the application returns 1412 the list of service offerings to the buyer. If the optimized list contains 1420 no service offerings, then the application returns 1422 the message, “no sellers found” to the buyer.

Certain embodiments may allow the buyer to specify more than two initial requirements. In such a system, the optimizer tries to match all requirements and then tries to match smaller and smaller subsets as shown in FIG. 14.

Certain embodiments allow the user to specify one or more requirements as inflexible. In such a system, these requirement(s) must be met before the optimizer will deem a particular service offering to match. For example, the buyer may specify price and delivery date, while specifying that the delivery date is inflexible and must be met. Alternatively, a cost-conscious buyer may indicate that cost is inflexible and that he will accept nonoptimum delivery dates to achieve his desired cost. Alternatively, the buyer may indicate that all requirements must be met for a match to occur.

### Storefront

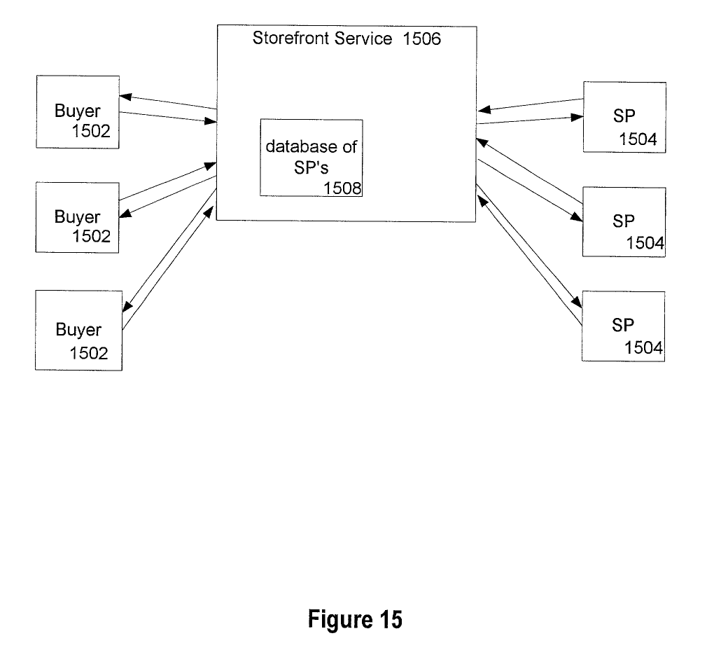

The storefront is a process that enables a buyer to purchase a service commodity. The service commodity generally has a deliverable that is easily priced and defined with little scope of ambiguity. Examples of such deliverables may include custom-created logos, web pages, animation, caricatures, or love songs. In a preferred embodiment, the buyer purchases a service commodity via a storefront by entering prompted information on a computer terminal. This information is transferred over a network 108 to the website 102. As shown in FIG. 15, a storefront service module 1506 uses the information entered by the buyer to assign a service request to one of a group of specially identified service providers. Once a service provider completes the service, the deliverable is returned to the storefront service module 1506 and the storefront service module 1506, in turn, presents the deliverable to the buyer for pickup. This process is discussed in greater detail below.

FIG. 15 is a block diagram of a preferred embodiment of a system for providing storefront services. The system includes a storefront service module 1506, at least one buyer 1502 and at least one service provider (SP) 1504. The storefront service module 1506 includes a database 1508 of service providers. Each buyer 1502 is connected to the storefront service module 1506 to make service requests and receive completed services. Each service provider 1504 is connected to the storefront service module 1506 to receive service projects and return completed services. This connection may be done via a network, such as the Internet, and may include LANs, WANs, wireless networks, intranets, etc.

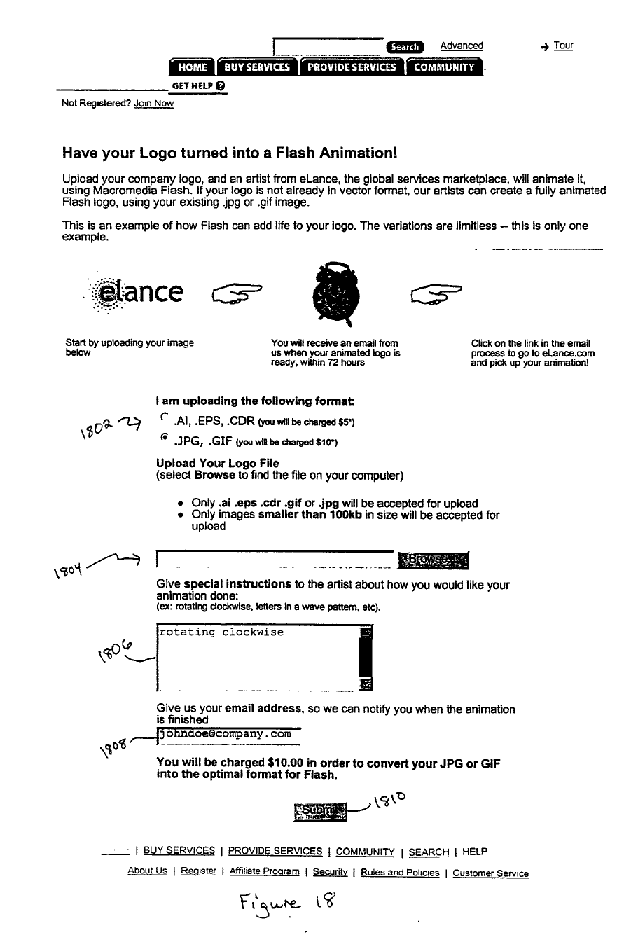

The buyer 1502 may be a buyer terminal, computer, or data processing device 104 similar to that described in FIG. 1, above. Generally, the buyer 1502 will access the user interface from the storefront service module 1506 such that the user may enter information necessary to complete a service request. These user interfaces are discussed in more detail in the description of FIGS. 18-20, below. The service provider 1504 preferably is a freelance service provider skilled in the particular service being offered on the storefront. The service provider 1504 may be a seller terminal, computer, or data processing device 106 similar to that described in FIG. 1 and, like the buyer 1052, the service provider 1504 will access the user interface from the storefront service module 1506.

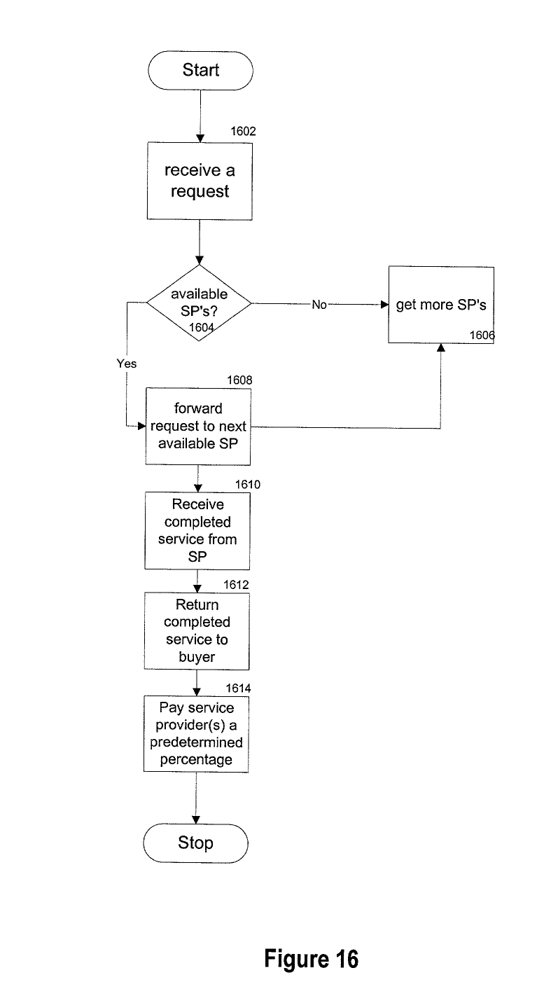

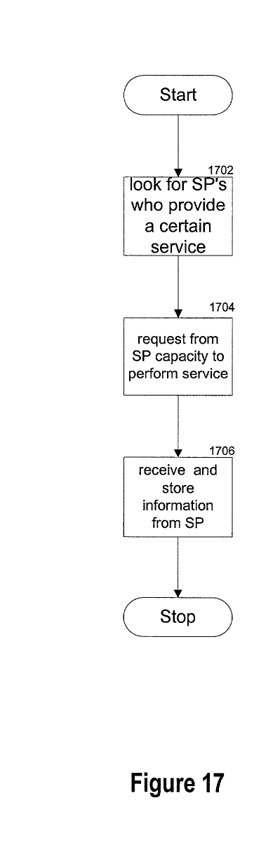

The storefront service module 1506 is located in the application 204 of the website 102. The buyer 1502 and service provider 1504 access the storefront service module 1506 via the network 108. In a preferred embodiment, the database 1508 of service providers is a subset of database 206. The database 1508 of service providers contains only those service providers 1504 who will be performing the specific service being offered on the storefront. For each service provider 1504, the database 1508 stores the affiliated storefront, the number of units of service the service provider 1504 can complete, and the time in which the service provider 1504 can complete those units of service. In a preferred embodiment, the unit of time is predetermined by the storefront service module 1506 thus requiring that the service provider 1504 provide only the number of units of service that that service provider 1504 can complete within the predetermined time period. If the service provider 1504 is currently working on one or more services, this information is also stored in database 1508. For instance, if the storefront sold caricatures, then database 1508 might store the fact that a particular service provider 1504 can complete ten caricatures in two days and that the service provider is currently working on five caricatures. The storefront service module 1506 uses this information to assign new service requests to service providers 1504. The storefront service module 1506 may be implemented as instructions stored in a memory and executed by a computer processor, although the invention is not limited to this embodiment. These instructions may be stored on a computer-readable medium, such as a floppy disk, CD ROM, or any other appropriate storage medium. The details of the functions of the storefront service module 1506 are further discussed in the description of FIGS. 16 and 17, below.

FIG. 16 is a flow diagram of a preferred embodiment of the storefront process. In step 1602, the storefront service module 1506 receives a request from a buyer 1502. This request contains information prompted by a user interface and used to fulfill the request. For instance, the information may include a file to be uploaded, a reputation threshold for the service provider who will complete the request, and an e-mail address at which the buyer can receive the deliverable. In one embodiment, the buyer 1502 may also request a specific service provider 1504 to perform the service. This allows the buyer to have additional control over the quality and style of the deliverable. The user interface is described in greater detail in FIG. 18 below. The storefront service module 1506 then determines, in step 1604, whether there are any available service providers to perform the requested service. This determination is made by evaluating the information in database 1508. The storefront service module checks database 1508 for available service providers 1504 that are identified with the storefront associated with the service request. A service provider 1504 is available if he or she is not currently working on the maximum number of projects that service provider 1504 can complete. For example, if a service provider 1504 can complete 10 projects in two days and that service provider 1504 is currently working on 10 projects, then that service provider is not available.

If there are no more available service providers, then the storefront service module 1506 gets more service providers in step 1606. There are no more available service providers 1504 for a given storefront when all service providers 1504 identified with that storefront are currently working on the maximum number of projects they can complete. This process of obtaining additional service providers 1504 is discussed in further detail below in the description of FIG. 17. If there are available service providers 1504, then the storefront service module 1506, in step 1608, forwards the service request to the next available service provider 1504.

The next available service provider 1504 may be chosen in any number of ways. In one embodiment, the service providers 1504 are ordered, and projects are assigned based on this ordering. The storefront service module 1506 checks for availability of the first service provider 1504 and if that service provider is available, the storefront service module 1506 assigns him the next project. This service provider 1504 is then moved to the end of the queue of service providers and the storefront service module 1506 assigns the next project to the service provider 1504 currently at the head of the queue, if that service provider is available. If a service provider 1504 at the head of the queue is not available, then that service provider is skipped and the storefront service module 1506 checks the availability of the next service provider. The storefront service module 1506 continues through the queue in this manner until it reaches an available service provider 1504. A service provider 1504 is moved to the end of the queue only after it is assigned a new project. Thus, if a service provider 1504 is skipped because she is unavailable, then she will maintain her order in the queue until she once again becomes available and is assigned a new project. The order of the service providers 1504 may, as an example, be alphabetical, based on reputation, based on the order in which the service providers 1504 signed up for the storefront, etc.

The storefront service module 1506 receives, in step 1610, the deliverable from the service provider 1504. In one embodiment, the service provider 1504 may post the deliverable on a common workspace 300 for the storefront. In step 1612, the storefront service module 1506 returns the deliverable to the buyer. The deliverable may be returned to the buyer via e-mail. Alternatively, the deliverable may be posted by the storefront service module 1506 on a web page and the URL for that web page sent to the buyer. In a preferred embodiment, the buyer pays with a credit card on the website 102 when the service request is submitted, and a predetermined percentage of this payment is forwarded, in step 1514, to the service provider 1504.

FIG. 17 is a flow diagram of a preferred embodiment of the process for adding a service provider 1504 to the database. This process is used in initially setting up the database of service providers 1504 and in adding additional service providers 1504 to the database if there are no available service providers 1504 to complete a new service request. In step 1702, the storefront service module 1506 looks for service providers 1504 to provide a certain service. In a preferred embodiment, the storefront service module 1506 uses the information stored in the overall database 206 on the website 102 to obtain a set of service providers 1504 that may be qualified to provide the required service. The storefront service module 1506, in step 1704, requests from each of these service providers 1504 the capacity of that service provider 1504 to perform the service. As an example, the storefront service module 1506 may request information from only those service providers with the highest ratings. In this manner, the website 102 may control the quality of the services provided over the storefront. Service providers 1504 not interested in providing services for a storefront may so indicate by, for example, returning a capacity of zero. This information about the capacity of the service provider 1504 is received and stored, in step 1706, in the database 1508 of service providers.

FIG. 18 is a screen shot of a user interface for a storefront service. In this embodiment, the storefront is for animating a company logo. The user interface includes space 1802 for the buyer to enter the type of file to be uploaded, a space 1804 for the buyer to upload the file containing the logo to be animated, a space 1806 for the buyer to give special instructions to the service provider, and a space 1808 for the buyer to enter an e-mail address. The user interface also includes a button 1810 that the buyer 1502 may press to submit the service request. In this embodiment, the user is given the option of choosing between two sets of file types. The space 1804 for the buyer to upload the file containing the logo allows the user to provide a specific file to the service provider. This file is accessed by the storefront service module 1506 via the network 108. The storefront service module 1506 forwards the file to the service provider 1504. While this embodiment of the storefront obtains a file from the buyer 1502, it is understood that the user interface may prompt the buyer 1502 for various other types information depending upon the type of service offered on the storefront. The user interface allows the buyer 1502 to enter an e-mail address in space 1808. This e-mail address is the necessary contact information that enables the storefront service module 1506 to return a finished service to the buyer 1502.

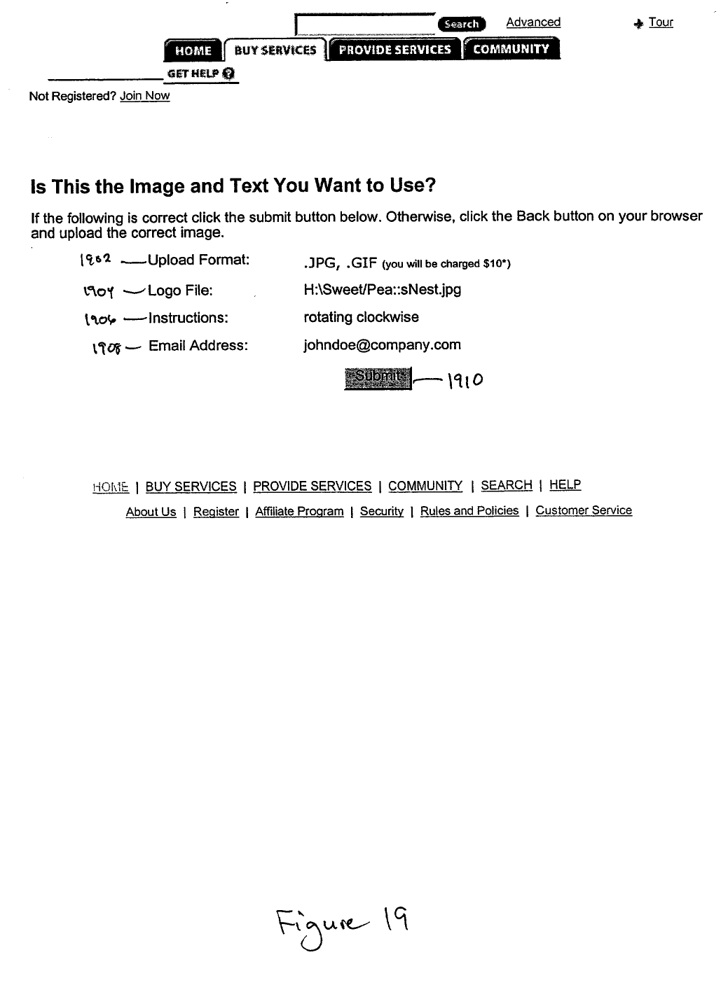

FIG. 19 is a depiction of a user interface for confirming the parameters of a storefront purchase. The buyer is presented with a summary of the information entered. In this example, the information includes the upload format 1902, the location and name 1904 of the file to be uploaded, special instructions 1906 and the buyer's e-mail address 1908. If the information is correct, the buyer may press the submit button 1910 to proceed with the purchasing process.

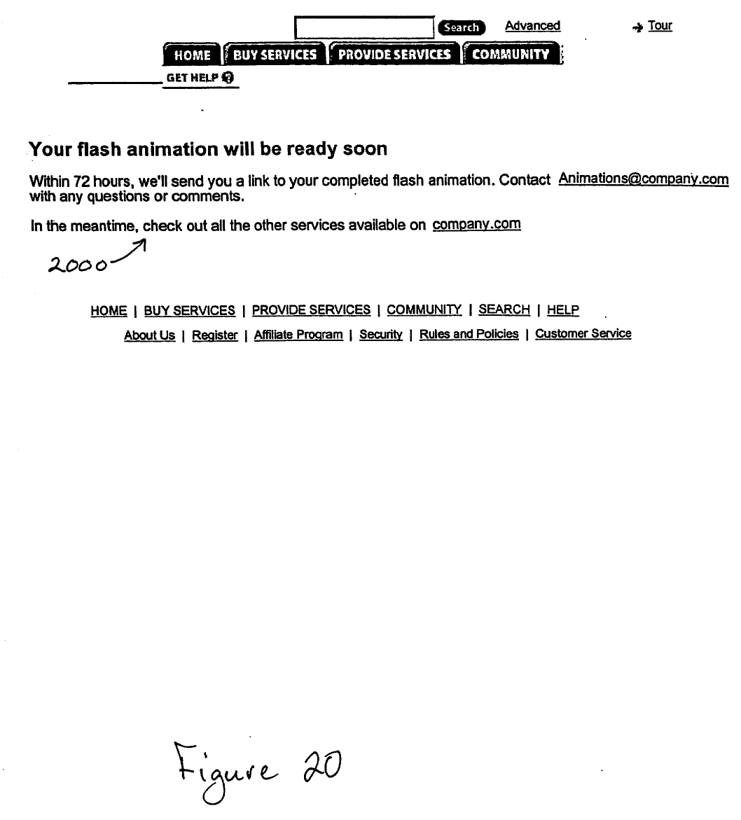

FIG. 20 is a user interface 2000 of a confirmation of a storefront purchase. The storefront services module 1506 confirms that the buyer 1502 has purchased a service from the storefront and informs the buyer 1502 that a link to the deliverable will be sent to the buyer.

We claim:

1. A computer implemented method, comprising:
establishing a database of service providers for providing a predefined service;
receiving a purchase request for the predefined service from a buyer;
assigning the purchase request to a service provider in the database; and
returning a deliverable from the service provider to the buyer.

2. The computer implemented method of claim 1, wherein establishing a database of service providers for providing a predefined service includes:
receiving from a service provider a number of units of service that the service provider can provide in a predetermined time period.

3. The computer implemented method of claim 1, wherein establishing a database of service providers for providing a predefined service includes:
determining a number of units of service that the service provider is currently working on.

4. The computer implemented method of claim 1, wherein establishing a database of service providers for providing a predefined service includes:
associating each service provider with a predefined service.

5. The computer implemented method of claim 1, wherein establishing a database of service providers for providing a predefined service includes:
adding a service provider to the database if the reputation of the service provider exceeds a predetermined threshold.

6. The computer implemented method of claim 1, wherein establishing a database of service providers for providing a predefined service includes:
adding a service provider to the database if the reputation of the service provider exceeds a predetermined threshold, in accordance with ratings of that service provider.

7. The computer implemented method of claim 1, wherein receiving a purchase request for the predefined service from a buyer includes:
receiving the number of deliverables requested.

8. The computer implemented method of claim 1, wherein receiving a purchase request for the predefined service from a buyer includes:
assuming one deliverable is requested.

9. The computer implemented method of claim 1, wherein receiving a purchase request for the predefined service from a buyer includes:
receiving a payment from the buyer.

10. The computer implemented method of claim 1, wherein receiving a purchase request for the predefined service from a buyer includes:
receiving a payment from the buyer prior to assigning the predefined service to a service provider.

11. The computer implemented method of claim 1, wherein receiving a purchase request for the predefined service from a buyer includes:
uploading a file required to complete the predefined service.

12. The computer implemented method of claim 1, wherein receiving a purchase request for the predefined service from a buyer includes:
receiving a reputation threshold from a buyer used to determine potential service providers.

13. The computer implemented method of claim 1, wherein receiving a purchase request for the predefined service from a buyer includes:
receiving special instructions from the buyer relating to the requested predefined service.

14. The computer implemented method of claim 1, wherein assigning the purchase request to a service provider in the database includes:
selecting a next service provider from an ordered queue of service providers.

15. The computer implemented method of claim 1, wherein assigning the purchase request to a service provider in the database includes:
sending a request for the requested predetermine service to a service provider.

16. The computer implemented method of claim 1, wherein assigning the purchase request to a service provider in the database includes:
sending a request for the requested predetermine service to a service provider whose reputation is above a reputation threshold entered by the buyer.

17. The computer implemented method of claim 1, wherein returning a deliverable from the service provider to the buyer includes:
receiving the deliverable from the service provider and returning the deliverable to the requesting buyer.

18. The computer implemented method of claim 1, wherein returning a deliverable from the service provider to the buyer includes:
adjusting a number of projects that the service provider is working on to reflect that the service has been delivered to the buyer.

19. In a computer system, an apparatus used by a buyer for purchasing predefined services over a network, comprising:
a web server for connecting to the network;
a storefront service module connected to the web server for obtaining information for completing a service request from the buyer, sending the information to one of a set of service providers, receiving a deliverable from the service provider, and sending the deliverable to the buyer; and
a database connected to the storefront service module for storing availability information for the set of service providers.
